(19) United States
(12) Patent Application Publication
(10) Pub. No.: US 2009/0140713 A1
(43) Pub. Date: Jun. 4, 2009

(54) REGULATOR CIRCUIT FOR TESTING INHERENT PERFORMANCE OF AN INTEGRATED CIRCUIT

(75) Inventor: Kenichirou Sugio, Miyazaki (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/326,330

(22) Filed: Dec. 2, 2008

(30) Foreign Application Priority Data
Dec. 3, 2007 (JP) 2007312487

(51) Int. Cl. G05F 5/00

(52) U.S. Cl. 323/299

(57) ABSTRACT

In testing the function of an integrated circuit which includes a power voltage regulator for smoothing a power voltage received on an input terminal so as to reach an adjustment target voltage level, and a voltage adjuster for adjusting the voltage level, the voltage adjuster being interconnected to a wiring which is to supply the power voltage of the adjustment target voltage level thus adjusted to internal logics produced by designing in advance for accomplishing a target function, the voltage adjuster is controlled to execute a function test with plural voltage levels, and, based on a result from the function test, the optimal voltage level is selected which is to be supplied to the internal logics. The inherent performance of the regulator circuit is measured without being affected by the parasitic resistances.

### BACKGROUND OF THE INVENTION

1. Field of the Invention

The present invention relates to an integrated circuit and more particularly to a regulator circuit for use in a power supply for logics.

2. Description of the Background Art

A regulator circuit for use in power supply for internal logics of an integrated circuit (IC) or large-scale integration (LSI) device is required to continuously produce a voltage equal to or higher than a predetermined value to a current load associated with internal logics. Hereinafter, the integrated circuit and large-scale integration are generically referred to as integrated circuit.

To such a regulator circuit, a semiconductor test device, or tester, is prepared to apply a pseudo current corresponding to power current for feeding the integrated circuit, for example, operational current flowing the internal logics mounted on the integrated circuit, to measure an output voltage level of the regulator circuit for determining the stability in output voltage with respect to the load current, which may be referred to as current load variation test. The current-applied voltage measurement with DC (Direct Current) test, such as current load test or operational power current test, is performed by waiting for an output involving fluctuation in voltage caused by a current applied by the tester for a certain period of time, e.g. until the voltage is stabilized, to thereby determine whether or not the regulator circuit is acceptable, which may be called pass/fail test.

Japanese patent laid-open publication No. 2006-170898 proposed a semiconductor device test circuit enabling a test mode of testing functions implemented on an integrated circuit without using a dedicated test terminal.

A serial-control type of voltage regulator was proposed by U.S. Pat. No. 5,828,206 to Hosono et al., in which current for a backup power source is prevented from flowing the internal circuit to thereby reduce its power consumption.

In the traditional method of using a tester to test a regulator circuit, however, a pseudo current corresponding to a current consumed by the internal logics of an integrated circuit is applied from outside. That may not cause a satisfactory load current to be given to the regulator circuit due to the parasitic resistances involved in both the input/output section of the integrated circuit and the evaluation tool, jig and the like. Parasitic resistance on the input/output section of an integrated circuit is a resistance of its wire bonding, for example. The evaluation tool or jig may be, for example, a probe or a tester board for use in testing or evaluation. Such shortage of the current may fail to determine the inherent capability of a regulator circuit.

When a tester is used to test a regulator circuit, the time setting of a measuring point at which a strobe is raised may cause the worst value of variation in output voltage from a regulator circuit, i.e. the lower limit value of a test standard for the regulator circuit, to be failed to detect. This problem requires another evaluation by means of observing the output voltage waveform from the regulator circuit, which consumes an extra evaluation period of time, and, additionally, may cause some of evaluation conditions to be skipped.

### SUMMARY OF THE INVENTION

It is an object of the present invention to provide a regulator circuit capable of measuring its inherent performance without being influenced with the parasitic resistances of its output section and an evaluation tool, for example, and without consuming time for testing and the possibility of skipping evaluation conditions. A method of testing such as regulator circuit is also provided.

In accordance with the present invention, a regulator circuit that comprises: a power voltage regulator for regulating a variation caused by a power voltage applied to an input terminal so as to reach an adjustment target voltage level to output a regulated voltage level from an output terminal; and a voltage adjuster for adjusting the voltage level outputted from the output terminal of the power voltage regulator.

The voltage adjuster may advantageously comprise: a plurality of load resistances to which the voltage level after stabilized is applied; and a plurality of switching devices that selectively combine the plurality of load resistances.

In accordance with the invention, an integrated circuit is provided which comprises internal logics produced by designing in advance for accomplishing a target function, and the regulator circuit stated above.

As described above, the present invention enables testing without consuming much time, and also eliminates possible drop of evaluation conditions, while measuring an inherent performance of a regulator circuit substantially free from effects of parasitic resistance caused for example at an output section of an integrated circuit and an evaluation tool.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of a regulator circuit device including a load current adjuster according to an illustrative embodiment of the present invention;

FIG. 2 shows a regulator circuit in a schematic circuit diagram according to the illustrative embodiment shown in FIG. 1;

FIGS. 3 and 4 are timing charts useful for understanding the operation of the illustrative embodiment;

FIG. 5 is a schematic block diagram, like FIG. 1, showing a regulator circuit device including a load current adjuster and a load resistance adjuster according to an alternative embodiment of the present invention;

FIGS. 6 and 7 are timing charts useful for understanding the operation of the alternative embodiment shown in FIG. 5;

FIG. 8 shows exemplified resistance values for use in the illustrative embodiments shown in FIGS. 1 and 5.

### DESCRIPTION OF THE PREFERRED EMBODIMENTS

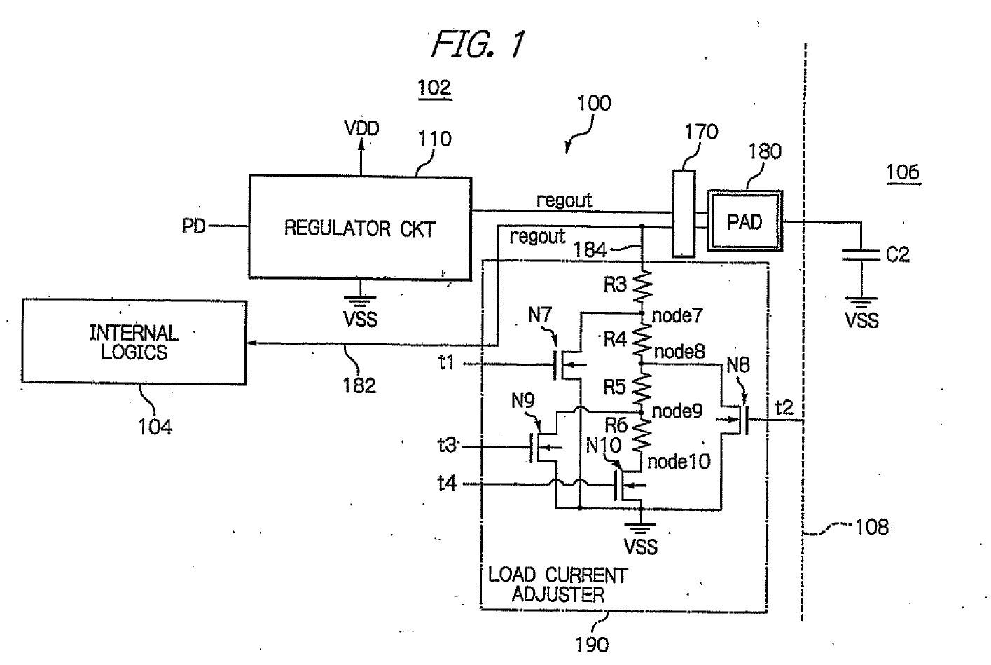

Referring to the accompanying drawings, what follows is a description of preferred embodiments according to the present invention. With reference first to FIG. 1, a regulator circuit device 100 formed on an integrated circuit 102 includes a regulator circuit 110, which is interconnected through an electrostatic discharge (ESD) protection circuit 170 to a connector pad (PAD) 180, which is also interconnected through the ESD protection circuit 170 to internal logics 104 designed to accomplish a target function or processing, so that the wiring connection extends from the regulator circuit 110 through the ESD protection circuit 170 to the connector pad 180 and is folded or returned there to pass the protection circuit 170 to the logics 104. The connector pad 180 is a connection terminal between the internal integrated circuit 102 and an external circuit 106, which are sectioned in the figure by a dotted line 108.

In the regulator circuit device 100, the connector pad 180 is further connected with one plate of an externally mounted output-stabilizing capacitor C2, which has its other plate connected to a reference potential VSS, which may be ground potential. In addition, the regulator circuit device 100 includes a load current adjuster 190 interconnected to a wiring connection 182 at an intermediate point 184 between the ESD protection circuit 170 and the internal logics 104.

The ESD protection circuit 170 consists of protection transistors such as MOS (Metal-Oxide Semiconductor) transistors for general use. The regulator circuit device 100 further includes another capacitor C1, which functions as a capacitance for phase compensation that cuts off a current component such as an inductive component so as to stabilize the operation of the circuitry, and may be, for example, phase-advancing capacitor. The capacitor C2 mounted outside the integrated circuit 104 is a capacitance protecting against a large load current to suppress the peak of the current.

The load current adjuster 190, which is thus connected with a branch line 184 branching from the wiring 182 extending from the regulator circuit 110 through the ESD protection circuit 170 and folded at the connector pad 180 to pass the protection circuit 170, forms a resistance ladder including a series connection of load resistances R3, R4, R5 and R6. In addition, between the reference, i.e. ground, potential VSS, and nodes 7, 8, 9 and 10, respectively inserted are N-type MOS field effect transistors (NMOS-FETs) N7, N8, N9 and N10 serving as switching devices.

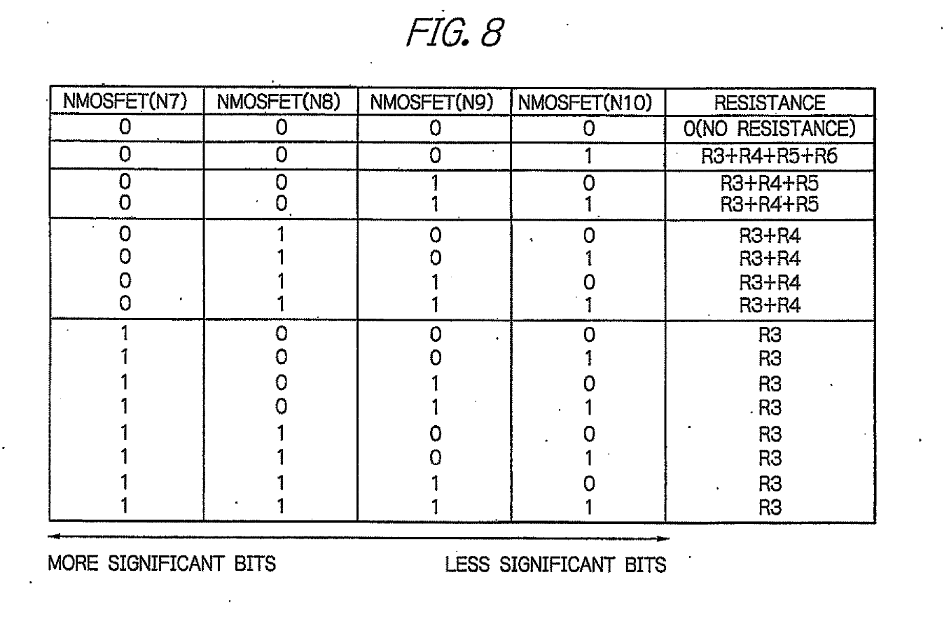

That structure of the load current adjuster 190 allows the load current adjuster 190 to theoretically provide 16 types of pattern as shown in FIG. 8. It is found that if upper bits are aligned in the order of NMOS transistors N7, N8, N9 and N10 the respective NMOS transistors are controlled by the conductive state of the NMOS transistors corresponding to the upper or more significant bit position. In practice, however, five resistance values can be set, including the OFF condition of the entire NMOS transistors. In FIG. 8, the value “0” indicates an “OFF” condition and “1” indicates an “ON” condition.

In the illustrative embodiment shown in FIG. 1, the load current adjuster 190 includes four load resistors R3, R4, R5 and R6, which are interconnected in series to each other as depicted so as to control the total resistance value changeable in response to the NMOS transistors N7, N8, N9 and N10, when selectively conductive or non-conductive, in such a manner that the total resistance value is resultant from selectively adding to the resistance of the topmost resistor R3 in the figure the resistance of one or ones of the resistors R4, R5 and R6 positioned downward.

The load current adjuster 190 is not specifically restricted to what is shown and described heretofore, but may be different in load resistance value or number of the resistors other than four. The NMOS transistors may be interconnected in parallel to the respective load resistors aligned in series. Alternatively, the load resistances may be interconnected in parallel, with any of which the NMOS transistors are interconnected in parallel. In such fashions, various resistance values can adjustably be established so as to obtain a target voltage level. In the illustrative embodiment, each of the load resistances R3, R4, R5 and R6 has the same value, e.g. 400Ω, although various resistance values are also acceptable.

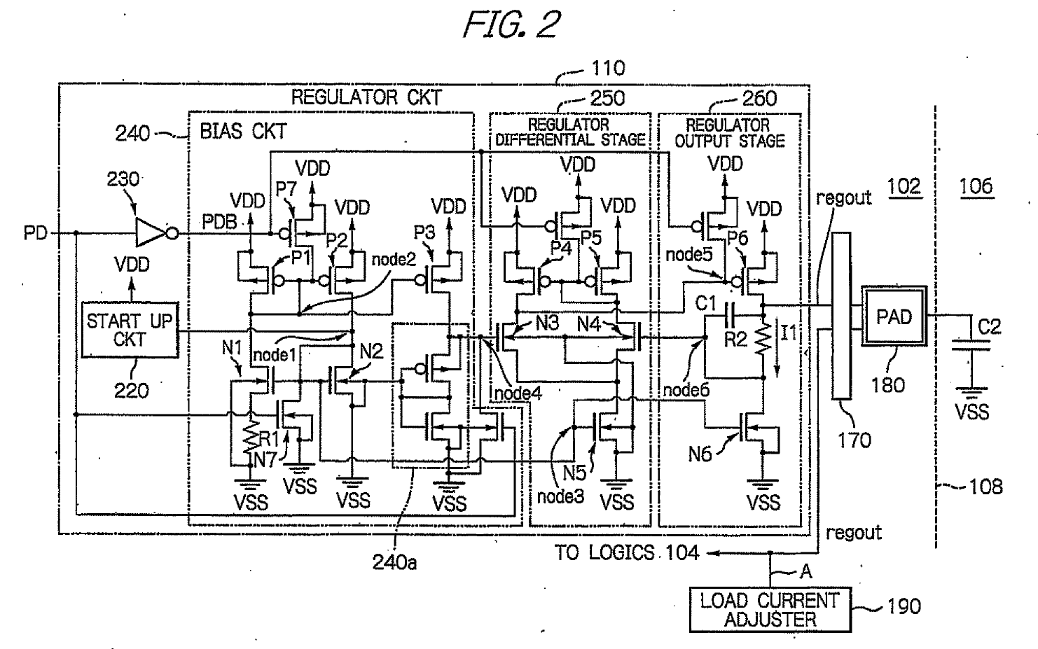

As seen from FIG. 2, the regulator circuit 110 serving as the internal logic power supply includes an inverter circuit 230 and a start-up circuit 220, which are connected with a bias circuit 240, although detailed circuit configuration is omitted. The start-up circuit 220 is responsible for start-up operation, and responsive to a voltage higher than that applied to the MOD transistor to conduct a current to thereby trigger the bias circuit 240. The bias circuit 240 is in turn connected via a regulator differential stage 250 to a regulator output stage 260, which is in turn connected to the ESD protection circuit 170 outside the regulator circuit 110. The inverter circuit 230 is connected to receive a power down signal PD to invert it into a power down base signal PDB.

The bias circuit 240 includes a constant current circuit, which comprises P-type MOS field-effect transistors (PMOS-FETs) P1 and P2, and NMOS transistors N1 and N2, and a resistance element R1 interconnected as illustrated, as well as a PMOS transistor P3 and a voltage trimmer 240a including a PMOS and an NMOS transistor connected as depicted, thus forming a circuit utilizing the ON resistance of the transistors so as to produce a constant voltage on a node 4 with fluctuation small against voltage and temperature changes. The constant voltage may be equal to, for example, 1.3V, serving as a reference voltage vref. The voltage trimmer 240a is adapted for finely tuning its voltage characteristics in order to attaining a voltage balance.

The regulator differential stage 250 connected with the output of the bias circuit 240 is operative with the reference voltage generated on the node 4 to cause the regulator output voltage regout to drop with a current I1 that flows through a resistance element R2 of the regulator output stage 260 to monitor the voltage on the node 6 so as to control the gate voltage developed on a node 5 of a PMOS transistor P6 so that the regulator output voltage regout is kept constant. The internal logics 102 is supplied with electric power from the regulator circuit 110, the power being folded back at and just passing through the connector pad 180.

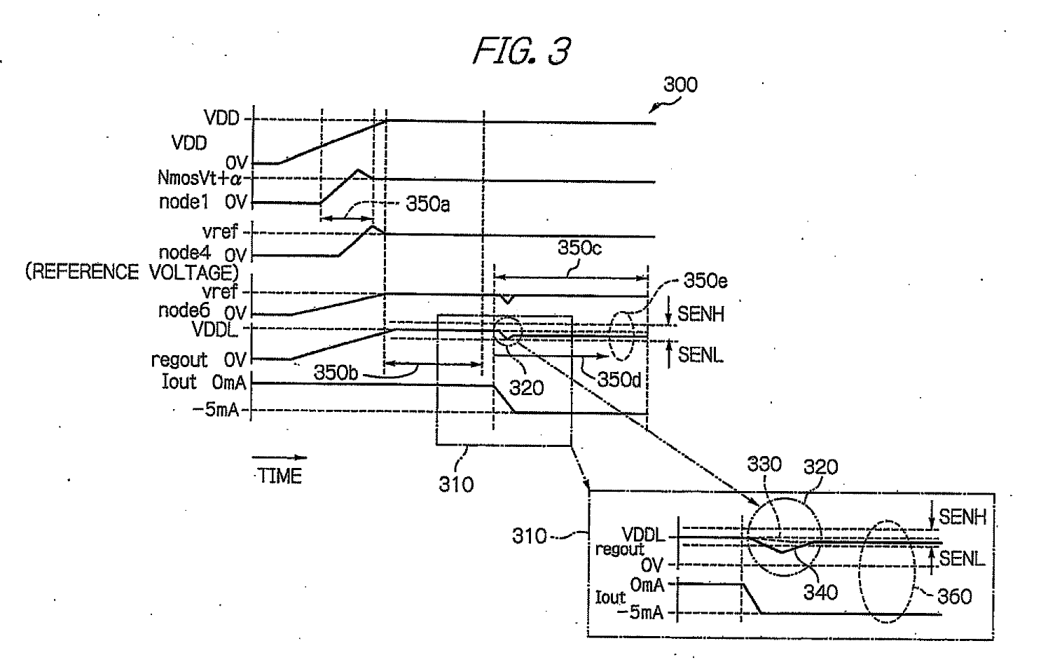

In operation, as shown in the timing chart 300 in FIG. 3, at the positive-going point of the power voltage VDD, which may be, for example 3.3 V±0.3 V, the start-up circuit 220 is activated to raise a voltage at node 1 to thereby activate the bias circuit 240. Then, after the reference voltage generated on the node 4 is stabilized, the voltage at the node 6 reaches the same level as the reference voltage so that the regulator output voltage regout is stabilized to the output voltage VDDL.

FIG. 3 also shows the regulator output voltage regout of the regulator circuit 110, a changing waveform part 310 of the output terminal applying current lout in such a case that current drawn from the tester side is equal to −5 mA, and another changing waveform part 320 of the regulator output voltage regout. Also shown are a start-up circuit operation section 350a, a voltage stabilization period of time 350b, a DC (Direct Current) test section 350c, a DC test strobe period of time 350d, where a strobe is raised in the DC test, and measuring points 350e and 360.

In the DC test, also shown are a High voltage SENH on the upper limit side of the operation tolerable range of the output voltage VDDL, which is a test standard, such as verification or product standard, of the regulator output voltage regout, as well as a Low voltage SENL on the lower limit side of the operation tolerable range of the output voltage VDDL, which is an target voltage level for adjustment and may be equal to 2.0 V.

At the time of DC test, where the load current adjuster 190 is not connected to the intermediate point 184 of the wiring over which the regulator output voltage regout is supplied to the internal logics 104, the regulator output voltage regout is depicted with a voltage changing waveform 340. Where the adjuster 190 is connected to the intermediate point 184, the regulator output voltage regout takes another voltage changing waveform 330.

If, during the DC measurement, the measuring point is erroneously set, then a failure may be ignored. For example, if a measuring point is not set near the waveform changing part 320 rather than at a point 350e or 360, then the regulator output voltage regout involves a measurement on the voltage changing waveform 340, which falls outside the Low side voltage SENL as specified in the standard as the lower limit value, resulting in failure in measurement. It would be difficult to finely move a strobe in the DC test for evaluation over the entire sections of DC test strobe period of time 350. That would make the evaluation by waveform observation consume a longer period of time. The provision of the load current adjuster 190 causes, however, the regulator output voltage regout to be measured in terms of the voltage changing waveform 330 so that the measurement value falls within the Low-side voltage SENL, the specified standard lower limit value, thus passing the test.

Then, the regulator circuit 110 for the internal logics 104 continues to output a voltage equal to or higher than a predetermined voltage value with respect to a current load caused by the internal logics 104 while in operation. Here, a pseudo operation power current is applied to the internal logics 104 from the tester in order to measure the output voltage level of the regulator circuit 110 for testing the output voltage stability against load current, which maybe referred to current load variation test.

For example, the current load variation test is to perform DC test, as shown in the timing chart 300, for measuring a voltage with current applied by drawing the current from tester side. In the example, the output terminal applied current, when drawn from tester side by the output terminal applying current lout, is set to −5 mA. Then, a pass/fail test or determination is made after waiting for a predetermined period of time until a fluctuation in output voltage caused by the applied, or drawn, current is stabilized.

As shown in FIG. 1, the load current adjuster 190, connected to the branch line 184 branching from the wiring 182 folded back via the ESD protection circuit 170 by the connector pad 180, has the load resistors R3, R4, R5 and R6 connected in series to each other to form a resistance ladder, and the NMOS transistors N7, N8, N9 and N10 are interconnected as switching devices respectively between nodes 7, 8, 9 and 10 and the reference potential VSS. With this configuration, the NMOS transistors N7, N8, N9 and N10 are controlled so as to increase the total resistance, i.e. reduce a current for load current adjustment. The resistance of the load resistors R3, R4, R5 and R6 may be the same as each other, or different from each other with different weight given. The dimension, or size, of the NMOS transistors N7, N8, N9 and N10 is so designed that the load resistors R3, R4, R5 and R6 have the ON resistance thereof satisfactorily small.

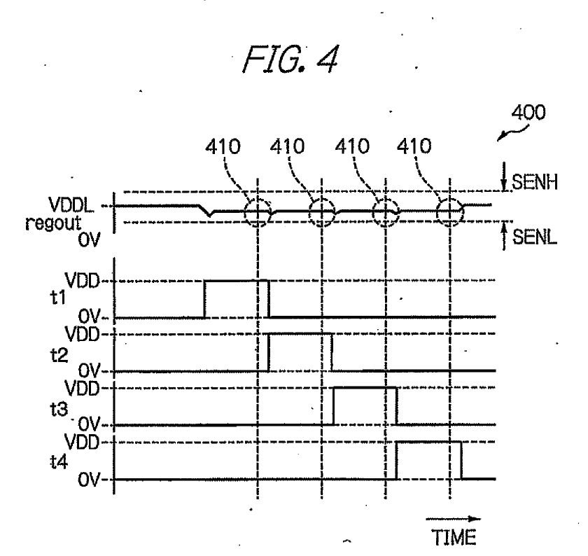

Now, referring to FIG. 4, timing chart 400, gate signals t1, t2, t3 and t4 of the NMOS transistors N7, N8, N9 and N10 are set to the “High” level voltage. That causes a load current to be generated on the output of the regulator 110, thus enabling an output load current test for the regulator 110.

After the gate signals t1, t2, t3 and t4 are stabilized, by switching over a voltage signal waveform from the gate signal t1 to the gate signal t4 in the load current adjuster 190 to change a measuring point 410, test is available, with a load current being changed, by the pass/fail test as done in the function test.

The similarity with the function test facilitates the strobe to be finely moved so that no waveform observation is required. For example, when the voltage value of the regulator output voltage regout, i.e. output voltage VDDL, =2.0 V and the load resistance R3=R4=R5=R6=400[Ω], the load current IL takes the following values in response to the gate signals t1, t2, t3 and t4 controlled:
When the gate signal t1 is ON (High), the load current IL=400=5 [mA], although the ON resistance of the NMOS transistor N7 is equal to or smaller than 5[Ω].
When the gate signal t2 is ON, the load current IL=2/800=2.5 [mA], although the ON resistance of the NMOS transistor N8 is equal to or smaller than 5[Ω].
When the gate signal t3 is ON, the load current IL=2/1200=1.67 [mA], although the ON resistance of the NMOS transistor N9 is equal to or smaller than 5[Ω].
when the gate signal t4 is ON, the load current IL=2/1600=1.25 [mA], although the NMOS transistor N10 is equal to or smaller than 5[Ω].

More specifically, for example, the gate signal t1 of the NMOS transistor N7 is set to “High” level (ON) in advance, and the load current value is specified as described above, and then in the function test, the shmoo plot, i.e. operational range evaluation, is prepared. Then, in the manner similar to the gate signal t1 of the NMOS transistor N7 being set to “High” level (ON), the gate signals t2, t3 of t4 of the NMOS transistors N8, N9 and N10 are sequentially set to the “High” level (ON) thereof, and the load current values are sequentially set to the values described above, while shmoo plots are drawn for the respective cases in the function test. Based on the result therefrom, optimal conditions are set on the gate signals t1, t2, t3 and t4 of the NMOS transistors N7, N8, N9 and N10.

The optimal conditions include:
setting the gate signals t1, t2, t3 and t4 of the NMOS transistors N8, N9 and N10 so as to minimize the power consumption of the internal logics 104;
setting the gate signals t1, t2, t3 and t4 of NMOS transistors N8, N9 and N10 according to the standard of the voltage value, i.e. the output voltage VDDL, for the regulator output voltage regout; and
setting the gate signals t1, t2, t3 and t4 of the NMOS transistors N8, N9 and N10 according to the amount of fluctuation of the output voltage VDDL.

The gate signals t1, t2, t3 and t4 under the optimal condition are basically stored in a register of the semiconductor measuring device as signal waveform data in the test mode associated with that condition, and is fixed thereto. Alternatively, they may be stored in an internal register of the integrated circuit 102. In a normal operation after shipped or during an on-board test also, such fixed on/off setting conditions for the gate signals t1, t2, t3 and t4 may be used. When used or tested by the user, a signal may be entered directly from the outside of the integrated circuit 102 to be transferred and controlled, so that a combination of the gate signals t1, t2, t3 and t4 may be adequately selected so as to supply an optimal power voltage to the internal logics 104.

Thus, the provision of the load current adjuster 190 within the integrated circuit 102 allows the current supply to approximate the actual load without being affected by parasitic resistances at the output section of the integrated circuit 102 or an evaluation tool so that inherent performance of the regulator circuit 110 can be measured. Controlling a load current with a logic signal enables a load current test to be carried out by a function test, so that, in evaluating, a shumoo plot can be taken in the order of several nanoseconds, and, without observing waveforms, confirmation that there are no failed points is available, thus facilitating the test.

Moreover, the load current adjuster 190 can be prepared with a simplified structure, for example, by utilizing unused cells on the integrated circuit 102. Thus, the load current adjuster 190 can be minimized in size, and can be implemented in multiple anywhere inside the integrated circuit 102 without occupying a large space. As the load current adjuster 190 is mounted inside the integrated circuit 102, the internal current can be free from the affections caused by the outside or surrounding of the integrated circuit 102 to be applied to the internal logics 104 without involving any loss.

Moreover, the use of the load current adjuster 190 can expand the tolerable range of the input voltage. The gate signals t1, t2, t3 and t4 based on the optimal condition in a predetermined test mode are basically stored in a register of the semiconductor measuring device and fixed thereto, so that the test mode based on the initially set optimal condition is available, and the test can be carried out with less time consumed.

The illustrative embodiment of the present invention uses the regulator circuit 110 of the type which uses as a reference voltage the threshold Vt. For example, NmosVt+α is in the range of 0.6 V to 0.7 V. The regulator circuit 110 may be of the type using an energy band gap as a reference voltage. The load current adjuster 190 is formed using the resistance elements. The load current adjuster 190 may be of the type including a weighted constant current source formed by, e.g. diodes or transistors.

Description of an alternative embodiment will be made according to the present invention. Like components are assigned with the same reference numerals, and a repetitive description of such components will be avoided for simplicity invention.

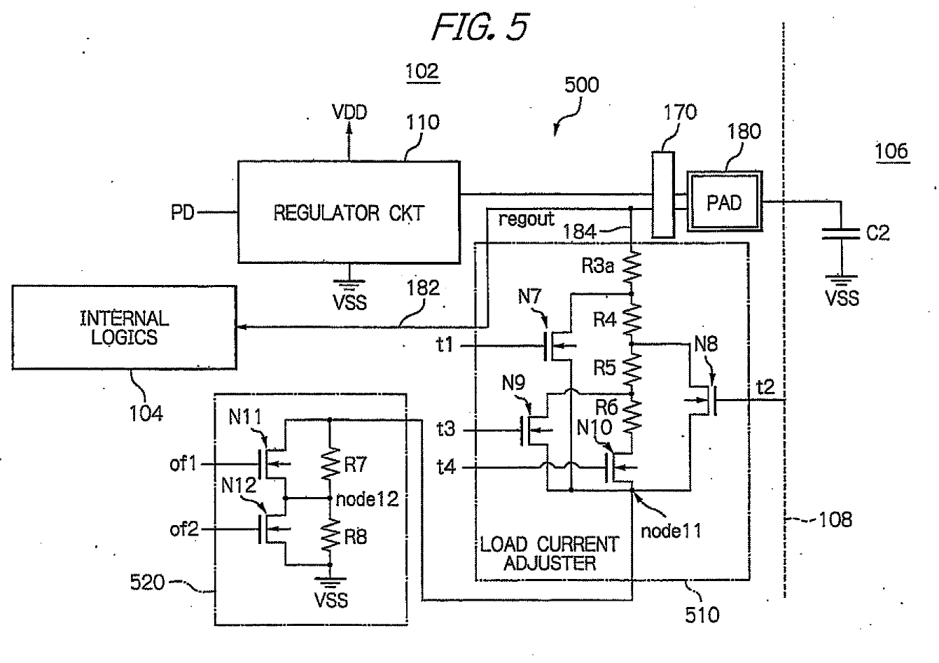

With reference to FIG. 5, an alternative embodiment of regulator circuit device 500 includes the regulator circuit 110, ESD protection circuit 170, connector pad 180 and capacitor C2, which are of the same interconnections and the reference potential VSS as the illustrative embodiment shown in and described with reference to FIG. 1. The regulator circuit 110 is also connected in a manner similar to the illustrative embodiment shown in FIG. 1. The load current adjuster 510 is interconnected to the branch line 184 branching from the wiring 182 that connects from the ESD protection circuit 170 to the internal logics 104.

The regulator circuit device 500 includes, as shown in the figure, a load current adjuster 510 which also has the same structure as the load current adjuster 190 except that the grounded node VSS of the load current adjuster 190 is replaced by a connecting node 11 by wiring to be connected to a load resistance adjuster 520, and that the load current adjuster 510 includes an additional load resistor R3a which has its resistance value smaller than the load resistance R3 of the load current adjuster 190.

In addition, in the regulator circuit device 500, the load resistance adjuster 520, connected with the load current adjuster 510, is adapted for adjusting a load current resistance in the three levels, i.e. load resistance R7, load resistance R8, and load resistances R7+R8. In the load resistance adjuster 520, between the node 11 of the load current adjuster 510 and the reference potential VSS, fine-tuning load resistances R7 and R8 are interconnected in series with each other for adjusting the voltage level to an adjustment target. The load resistance adjuster 520 also includes NMOS transistor N11 and N12 functioning as switching devices that short-circuits any of the load resistors R7 and R8.

The load resistors R7 and R8 may be set to an appropriate resistance value according to the output voltage of the regulator output voltage regout. Since they are load resistances for fine-tuning, however, the resistance values thereof may preferably be lower than the load resistance R3a (which may be smaller than R3), R4, R5 and R6. Similarly to the illustrative embodiment shown in FIG. 1, the load current adjuster 510 can essentially attain five resistance values including the case of both of the transistors N11 and N12 in the OFF state thereof, as seen from FIG. 8.

In order to adjust the voltage level to a target value, the load current adjuster 510 may accomplish the rough adjustment of its total resistance value by various resistance values, which can be set by either changing the load resistance values and interconnecting the NMOS transistors in parallel to the load resistances connected in series to each other, or by arranging the load resistors in parallel with the NMOS transistors interconnected as appropriately.

In the alternative embodiment, the regulator circuit device 500 requires that the ON resistance of NMOS transistors N11 and N12 be satisfactorily smaller than the resistance value of the load resistors R7 and R8, similar to the regulator circuit device 100. The node 11 is required to have a positive offset voltage.

In operation, with reference to the timing chart 600 shown in FIG. 6, in a measurement range 610, a voltage is applied to the regulator output voltage regout to measure a current to thereby determine a combined resistance of the load resistances R3a+R8. In the measurement range 610, the power-down signal PD of the regulator circuit 110 is set to its “High” level, and then the output of the regulator circuit 110 is set to its high-impedance state “Hi-Z” to render the gate signals t1 and of1 to the “High” level thereof to thereby turn the NMOS transistors N7 and N11 ON. Then, a voltage is applied to the output terminal of the regulator circuit 110, and both the current value obtained from the current that flows then and the voltage applied for the measurement are used to derive a combined resistance of load resistors R3a and R8.

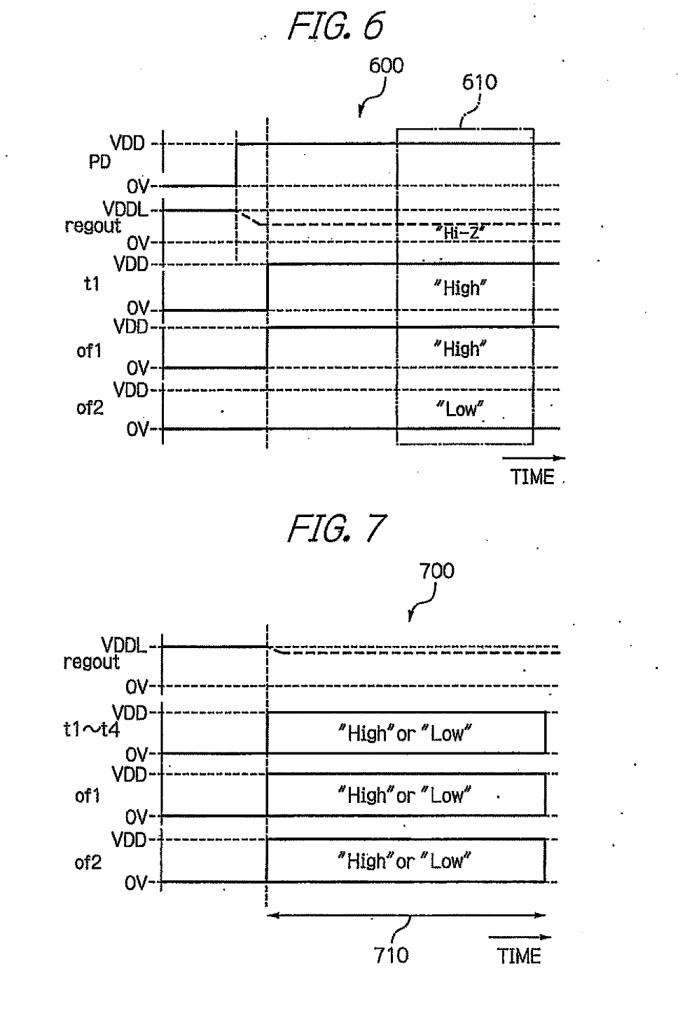

With reference to the timing chart 700 shown in FIG. 7, based on the gate signals t1, t2, t3 and t4 of the NMOS transistors N7, N8, N9 and N10, the resistance values of load resistors R3a, R4, R5 and R6 are roughly adjusted in order to adjust the voltage level to an adjustment target. Using the gate signals of1 and of2 of the NMOS transistors N11 and N12, the load resistors R7 and R8 are adjusted for fine-tuning an error such as offset as far as possible.

More specifically, based on a resistance value measured in the timing chart 600, if the resistance value of the load current adjuster 510 is lower, the gate signals of1 of2 are then both set to the “Low” level thereof to increase the resistance value. Otherwise, namely, if the resistance value of the load current adjuster 510 is near the standard or reference value, the gate signal of1 is then set to its “High” level, and the gate signal of2 is to its “Low” level. Thus, the resistance value is finely tuned. When the resistance value of the load current adjuster 510 is higher, the gate signals of1 and of2 are both set to the “High” level thereof to thereby prevent the resistance value from exceeding the current value.

In addition, similarly to the illustrative embodiment shown in FIG. 1, the gate signals t1, t2, t3, t4, of1 and of2 of the NMOS transistors N7, N8, N9, N10, N11 and N12 are defined in advance based on the load current value, and a shmoo plot is prepared in a function test. Based upon a result from the test, an optimal condition is set, i.e. set the gate signals t1, t2, t3, t4, of1 and of2 of the NMOS transistors N7, N8, N9, N10, N11 and N12.

The gate signals t1, t2, t3, t4, of1 and of2 based on the optimal condition as well as the signal waveform of the test mode under that condition are basically stored in a register of the semiconductor measuring device and thus fixed. Alternatively, they may be stored in an internal register of the integrated circuit 102. In the normal operation after shipped or during a non-board test also, the fixed on/off setting condition for the gate signals t1, t2, t3, t4, of1 and of2 may be used.

In such a case, as shown in the timing chart 700, if the combined resistance value of the load resistors R3a+R8 is smaller than the standard or reference value, then the gate signals of1 and of2 of the NMOS transistors N11 and N12 are set to the “Low” level thereof for adding the resistance value of the load resistor R7. If the combined resistance value of the load resistors R3a+R8 is substantially equal to the standard value, then the control signals are set such that the gate signal of1=“High” and the gate signals of2=“Low”. The combined resistance value of the load resistors R3a+R8 is higher than the standard value, then both gate signals of 1 and of2 are set to the “High” level thereof to subtract the resistance value of the load resistor R8.

In the alternative embodiment, an output load current test is performed, with the resistance adjusted, similarly to the regulator circuit 110 in the illustrative embodiment shown in FIG. 1.

The load current adjuster 510 thus provided inside the integrated circuit 102 allows a condition near the actual load current supply to be obtained so that the inherent performance of the regulator circuit 110 can be measured without being affected by the parasitic resistances as of the output part of the integrated circuit 102 and an evaluation tool.

The load resistors R3a, R4, R5 and R6 built in the load current adjuster 510 are used to roughly adjust a resistance value to the adjustment target voltage level. The provision of the resistance load resistance adjuster 520 including the load resistors R7 and R8 having the resistance values lower than the load resistors R3a, R4, R5 and R6 allows the resistance value to be finely tuned to an adjustment target voltage level, and the variation of the built-in resistances to be finely adjusted. Thus, the variation in load current can be reduced much less than the illustrative embodiment shown in and described with reference to FIG. 1. Generally, such built-in resistors have ±20% in manufacturing variation.

In addition, by controlling the load current by logic signals, the load current test can be performed as a function test so that, during evaluation, a shmoo plot can be collected in the order of several nanoseconds, and it can be confirmed, without observing waveforms, whether or not there are failure points, thus facilitating the test.

The load current adjuster 510 and load resistance adjuster 520 are prepared with a simpler structure, for example, by utilizing unused cells, and thus the size of the load current adjuster 510 and load resistance adjuster 520 can be minimized so that they may can be placed in plural anywhere insides the integrated circuit 102.

The load current adjuster 510 and load resistance adjuster 520 are thus placed inside the integrated circuit 102, and therefore the internal current is fully given to the internal logics 104, thus eliminating effects from the exterior or periphery of the integrated circuit 102. Use of the load resistance adjuster 520 further expands the tolerable range of the input voltage. The gate signals t1, t2, t3, t4, of1 and of2 based on the optimal condition in a test mode set in advance are basically stored in a register of the semiconductor measuring device as fixed values. Thus, based on the optimal conditions initially set, the test mode can be used for testing without consuming much time.

The load current adjuster 510 is formed using resistance elements. Alternatively, the load current adjuster 500 may be of a weighted constant current source, for example. When used by the user or tested, a signal may be entered directly from the outside of the integrated circuit 102 to be transferred and controlled, and a combination of the gate signals t1, t2, t3, t4, of1 and of2 can be appropriately selected so that an optimal power voltage is supplied to the internal logics 104.

In accordance with an aspect of the present invention, a method of testing a function of an integrated circuit which includes: a power voltage regulator that smoothes a power voltage received on an input terminal so as to reach an adjustment target voltage level; and a voltage adjuster for adjusting the voltage level, the voltage adjuster being interconnected to a wiring which is to supply the power voltage of the adjustment target voltage level adjusted by the power voltage regulator to internal logics produced by designing in advance for accomplishing a target function comprises controlling the voltage adjuster to execute a function test with a plurality of voltage levels, and selecting optimal one of the plurality of voltage levels which is to be supplied to the internal logics based on a result from the function test.

In the method of testing, the voltage adjuster includes: a plurality of load resistors to which the voltage level is applied, and a plurality of switching devices that selectively combine the plurality of load resistors.

The entire disclosure of Japanese patent application No. 2007-312487 filed on Dec. 3, 2007, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A regulator circuit comprising:
a power voltage regulator for regulating a variation caused by a power voltage applied to an input terminal so as to reach an adjustment target voltage level to output a regulated voltage level from an output terminal; and
a voltage adjuster for adjusting the voltage level outputted from the output terminal of said power voltage regulator.

2. The regulator circuit according to claim 1, wherein said voltage adjuster comprises;
a plurality of load resistances to which the voltage level after stabilized is applied; and
a plurality of switching devices that selectively combine said plurality of load resistances.

3. An integrated circuit comprising:
internal logics produced by designing in advance for accomplishing a target function; and
a regulator circuit which comprises:
a power voltage regulator for regulating a variation caused by a power voltage applied to an input terminal so as to reach an adjustment target voltage level to output a regulated voltage level from an output terminal to thereby feed said internal logics; and
a voltage adjuster interconnected between the output terminal of said power voltage regulator and said internal logics for adjusting the voltage level outputted from the output terminal.

4. The integrated circuit according to claim 3, wherein said voltage adjuster comprises:
a plurality of load resistances to which the voltage level after stabilized is applied; and
a plurality of switching devices that selectively combine said plurality of load resistances.
